(19) United States
(12) Patent Application Publication
(10) Pub. No.: US 2026/0164425 A1
(43) Pub. Date: Jun. 11, 2026

(54) DYNAMIC UPLINK GRANT FOR A SET OF CONSECUTIVE DUTY-CYCLE-BASED SYMBOLS

(71) Applicant: QUALCOMM Incorporated, San Diego, CA (US)

(72) Inventors: Yavuz YAPICI, Florham Park, NJ (US); Juergen CEZANNE, Ocean Township, NJ (US); Junyi LI, Greentown, PA (US)

(21) Appl. No.: 18/969,680

(22) Filed: Dec. 5, 2024

(51) Int. Cl. H04W 72/1263; H04L 5/00; H04W 72/21

(52) U.S. Cl. CPC H04W 72/1263; H04L 5/0053; H04W 72/21

(57) ABSTRACT

Various aspects of the present disclosure generally relate to wireless communication. In some aspects, a network node may transmit an indication of a dynamic uplink grant for a set of consecutive duty-cycle-based symbols. The network node may receive the set of consecutive duty-cycle-based symbols based at least in part on the dynamic uplink grant. Numerous other aspects are described.

### FIELD OF THE DISCLOSURE

Aspects of the present disclosure generally relate to wireless communication and specifically relate to techniques, apparatuses, and methods associated with a dynamic uplink grant for a set of consecutive duty-cycle-based symbols.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a network node. The method may include transmitting an indication of a dynamic uplink grant for a set of consecutive duty-cycle-based symbols (e.g., symbols that are separated in time based at least in part on a duty cycle as described below). The method may include receiving the set of consecutive duty-cycle-based symbols based at least in part on the dynamic uplink grant.

Some aspects described herein relate to a method of wireless communication performed by a user equipment (UE). The method may include receiving an indication of a dynamic uplink grant for a set of consecutive duty-cycle-based symbols. The method may include transmitting the set of consecutive duty-cycle-based symbols based at least in part on the dynamic uplink grant.

Some aspects described herein relate to an apparatus for wireless communication at a network node. The apparatus may include one or more memories and one or more processors coupled to the one or more memories. The one or more processors may be configured to transmit an indication of a dynamic uplink grant for a set of consecutive duty-cycle-based symbols. The one or more processors may be configured to receive the set of consecutive duty-cycle-based symbols based at least in part on the dynamic uplink grant.

Some aspects described herein relate to an apparatus for wireless communication at a UE. The apparatus may include one or more memories and one or more processors coupled to the one or more memories. The one or more processors may be configured to receive an indication of a dynamic uplink grant for a set of consecutive duty-cycle-based symbols. The one or more processors may be configured to transmit the set of consecutive duty-cycle-based symbols based at least in part on the dynamic uplink grant.

Some aspects described herein relate to a non-transitory computer-readable medium that stores a set of instructions for wireless communication by a network node. The set of instructions, when executed by one or more processors of the network node, may cause the network node to transmit an indication of a dynamic uplink grant for a set of consecutive duty-cycle-based symbols. The set of instructions, when executed by one or more processors of the network node, may cause the network node to receive the set of consecutive duty-cycle-based symbols based at least in part on the dynamic uplink grant.

Some aspects described herein relate to a non-transitory computer-readable medium that stores a set of instructions for wireless communication by a UE. The set of instructions, when executed by one or more processors of the UE, may cause the UE to receive an indication of a dynamic uplink grant for a set of consecutive duty-cycle-based symbols. The set of instructions, when executed by one or more processors of the UE, may cause the UE to transmit the set of consecutive duty-cycle-based symbols based at least in part on the dynamic uplink grant.

Some aspects described herein relate to an apparatus for wireless communication. The apparatus may include means for transmitting an indication of a dynamic uplink grant for a set of consecutive duty-cycle-based symbols. The apparatus may include means for receiving the set of consecutive duty-cycle-based symbols based at least in part on the dynamic uplink grant.

Some aspects described herein relate to an apparatus for wireless communication. The apparatus may include means for receiving an indication of a dynamic uplink grant for a set of consecutive duty-cycle-based symbols. The apparatus may include means for transmitting the set of consecutive duty-cycle-based symbols based at least in part on the dynamic uplink grant.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of coherent wireless communication and an example of noncoherent wireless communication, in accordance with various aspects of the present disclosure.

FIGS. 4A and 4B are diagrams illustrating a first example and a second example of consecutive duty-cycle-based symbols, in accordance with the present disclosure.

FIGS. 5A, 5B, and 5C are diagrams illustrating a first example, a second example, and a third example, of dynamic scheduling mechanisms for consecutive duty-cycle-based symbols, in accordance with the present disclosure.

FIG. 6 is a diagram illustrating an example of a wireless communication process between a network node and a user equipment (UE), in accordance with the present disclosure.

FIG. 7 is a diagram illustrating an example process performed, for example, at a network node or an apparatus of a network node, in accordance with the present disclosure.

FIG. 8 is a diagram illustrating an example process performed, for example, at a UE or an apparatus of a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Coherent communications may be based at least in part on a transmitter transmitting a pilot and/or reference signal and a receiver using the pilot and/or reference signal to compute a channel estimate of a physical channel. As part of the coherent communications, the receiver may use the channel estimation to adjust or modify demodulation and/or decoding parameters. Some channel conditions may be not suitable for coherent communications, such as a low signal-to-noise ratio (SNR) operating environment in which an SNR observed by the receiver satisfies a low threshold, resulting in increased decoding errors at the receiver. In such an operating environment, noncoherent communications may provide reduced decoding errors, relative to coherent communications. In noncoherent communications, the transmitter does not transmit any pilot signals or reference signals, and the receiver directly demodulates and decodes the received symbols without computing a channel estimation for adjustments. In some cases, a measurement metric observed at the receiver (e.g., a received power level and/or an observed SNR) may indicate when current channel conditions are not suitable for coherent communications. As a result, the transmitter and the receiver may switch to noncoherent communications to mitigate decoding errors.

One example of noncoherent communications includes a duty-cycle-based symbol. For duty-cycle-based symbols, a transmitter may transmit a first symbol as a first pulse that spans a time period of Tₛ in a first portion of a first instance of a duty cycle. The transmitter may transmit a second symbol as a second pulse that also spans the time period of Tₛ in a second instance of the duty cycle. Accordingly, the first pulse and the second pulse are non-contiguous with one another in the time domain, and may occupy non-contiguous time-frequency resources. Collectively, the first symbol and the second symbol may alternatively be referred to as consecutive duty-cycle-based symbols.

Being a noncoherent transmission, a set of consecutive duty-cycle-based symbols may enable more reliable communications (e.g., reduced recovery errors) in a low SNR environment, relative to coherent transmissions. Scheduling duty-cycle-based symbols using scheduling that is configured and/or optimized for coherent transmissions may lead to inefficiencies, such as increased power consumption at a user equipment (UE) and/or increased signaling overhead. For example, scheduling techniques that are optimized for coherent transmissions may be based at least in part on allocations that use contiguous and/or adjacent air interface resources (e.g., contiguous resource scheduling) to maximize resource efficiencies and/or to minimize signaling overhead. To illustrate, various radio access technologies (RATs) allocate air interface resources based at least in part on using contiguous time-frequency resources and, in some cases, the contiguous time-frequency resources may be scheduled periodically or semi-persistently. Using scheduling that is based at least in part on contiguous time-frequency resource allocations may be sub-optimal for duty-cycle-based symbols that occupy non-contiguous time-frequency resources. To illustrate, a contiguous resource scheduling mechanism may schedule contiguous air interface resources for a set of contiguous duty-cycle-based symbols, and some air interface resources may go unused, such as the air interface resources between the duty-cycle-based symbols. Inefficient air interface resource allocations that result in unused air interface resources may lead to a decreased availability of air interface resources for other communications, and the decreased availability of air interface resources may result in reduced data throughput and/or increased data transfer latencies in a wireless network.

Various aspects relate generally to a dynamic uplink grant for a set of consecutive duty-cycle-based symbols. Some aspects more specifically relate to a network node scheduling a UE with a dynamic uplink grant for one or more duty-cycle-based symbols, some of which may be included in a set of contiguous duty-cycle-based symbols. The dynamic uplink grant may allocate non-contiguous time-frequency resources to the UE. In some aspects, a network node may transmit an indication of a dynamic uplink grant for a set of consecutive duty-cycle-based symbols. For instance, the network node may transmit the indication of the dynamic uplink grant for the set of consecutive duty-cycle-based symbols based at least in part on transmitting a respective dynamic uplink grant for each duty cycle-based symbol in respective downlink control information (DCI). That is, the dynamic uplink grant for an entirety of consecutive duty-cycle-based symbols may be based at least in part on multiple DCI. As another example, the network node may transmit the indication of the dynamic uplink grant in a single DCI transmission that allocates non-contiguous air interface resources. The network node may receive the set of consecutive duty-cycle-based symbols based at least in part on the dynamic uplink grant.

In some aspects, a UE may receive an indication of a dynamic uplink grant for a set of consecutive duty-cycle-based symbols. As one example, the UE may receive a respective dynamic uplink grant for each duty-cycle-based symbol in the set of consecutive duty-cycle-based symbols, such as by receiving respective DCI that schedules a respective duty-cycle-based symbol. As another example, the UE may receive a single DCI that allocates non-contiguous air interface resources for an entirety of the set of contiguous duty-cycle-based symbols. The UE may transmit the set of consecutive duty-cycle-based symbols based at least in part on the dynamic uplink grant.

Particular aspects of the subject matter described in this disclosure can be implemented to realize one or more of the following potential advantages. In some examples, by transmitting an indication of a dynamic uplink grant for a set of duty-cycle-based symbols, the described techniques can be used to enable a network node to increase an efficiency with respect to how air interface resources are allocated and used by reducing the allocation of unused air interface resources. To illustrate, by allocating non-contiguous air interface resources based at least in part on a duty cycle of the symbols, the network node may allocate, to other communications, air interface resources that are positioned between the duty-cycle-based symbols. Increasing an efficiency of how air interface resources are used and/or allocated may increase an availability of air interface resources for other communications, resulting in increased data throughput and/or reduced data transfer latencies in a wireless network.

As described above, wireless communication systems may be deployed to provide various services, which may involve carrying or supporting voice, text, other messaging, video, data, and/or other traffic. Some wireless communications systems may employ multiple-access RATs. The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

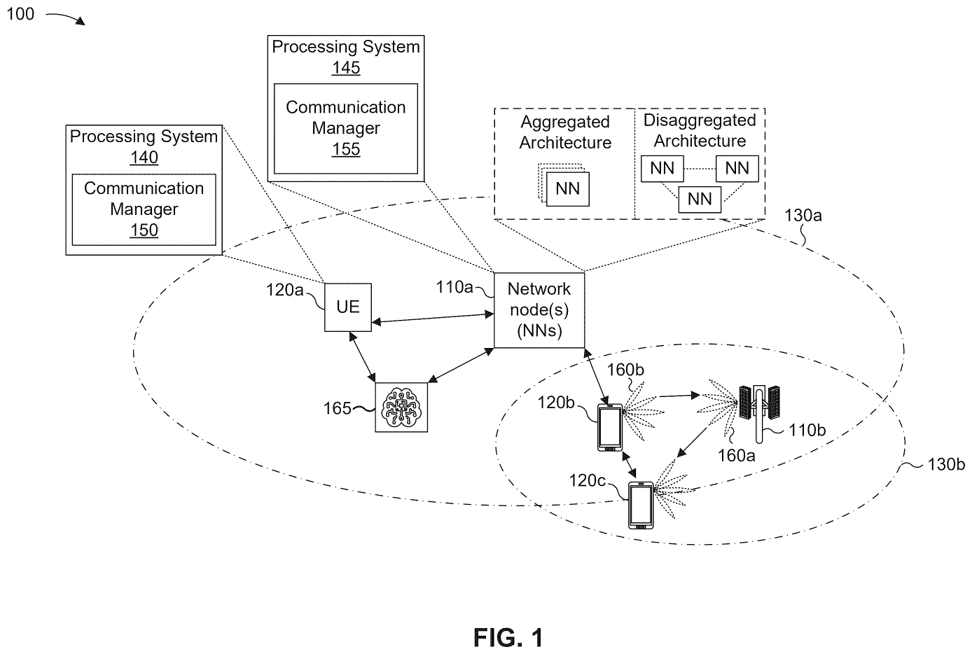

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHZ), FR4 (52.6 GHz through 114.25 GHz), and FR5 (114.25 GHz through 300 GHz). Although a portion of FR1 is greater than 6 GHZ, FR1 is often referred to (interchangeably) as a “sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

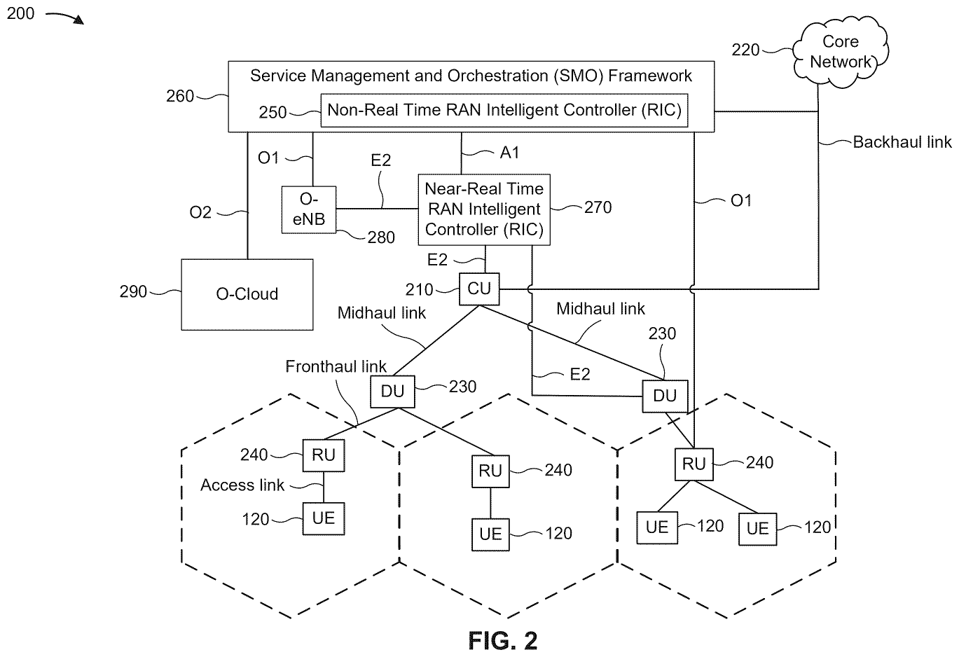

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

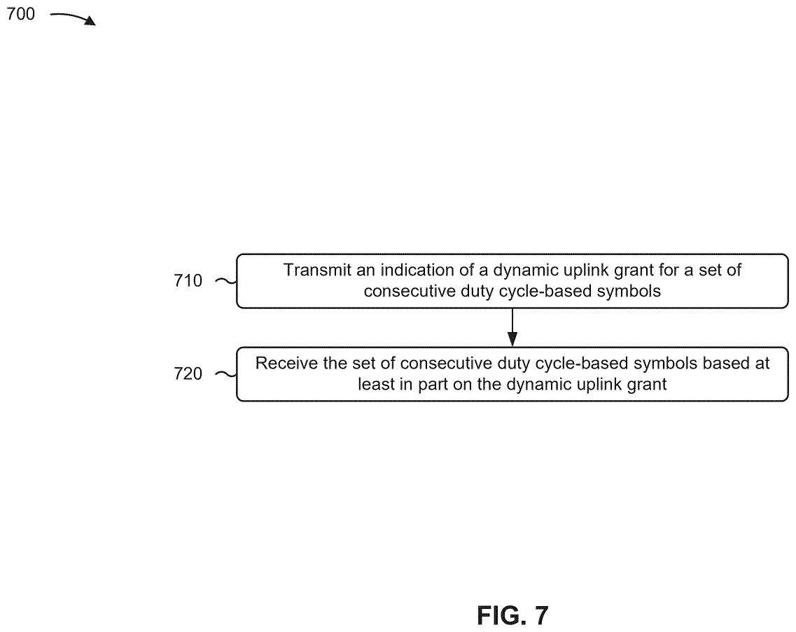

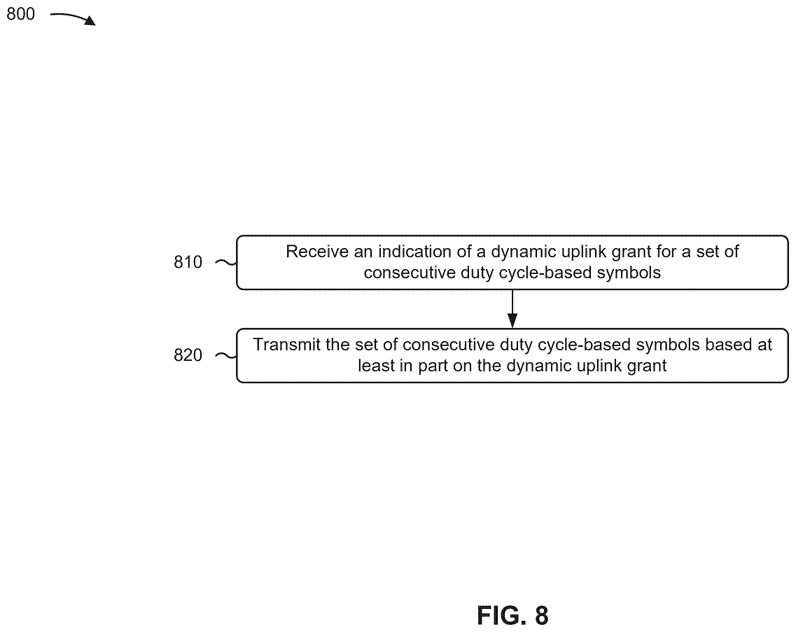

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a dynamic uplink grant for a set of consecutive duty-cycle-based symbols, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

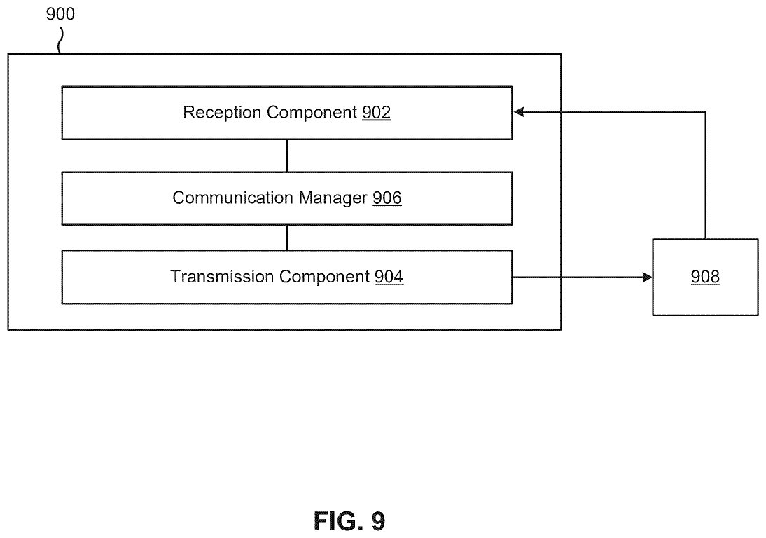

In some aspects, a network node (e.g., a network node 110) includes means for transmitting an indication of a dynamic uplink grant for a set of consecutive duty-cycle-based symbols; and/or means for receiving the set of consecutive duty-cycle-based symbols based at least in part on the dynamic uplink grant. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

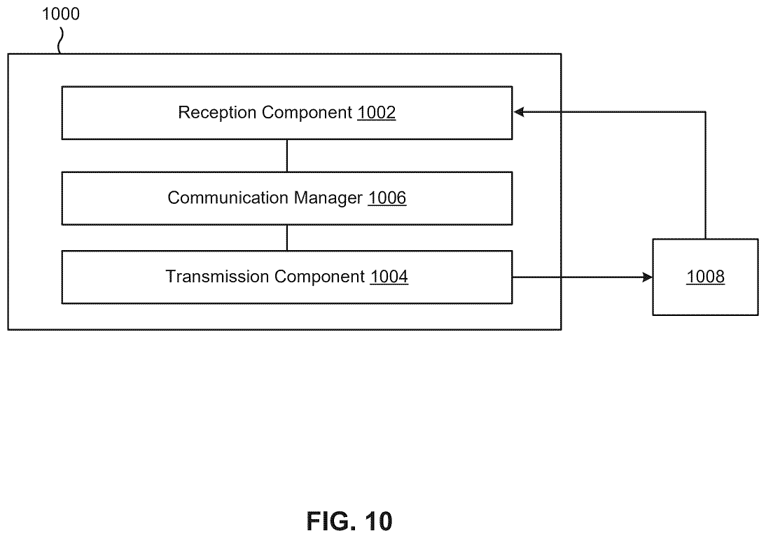

In some aspects, a UE (e.g., a UE 120) includes means for receiving an indication of a dynamic uplink grant for a set of consecutive duty-cycle-based symbols; and/or means for transmitting the set of consecutive duty-cycle-based symbols based at least in part on the dynamic uplink grant. The means for the UE to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

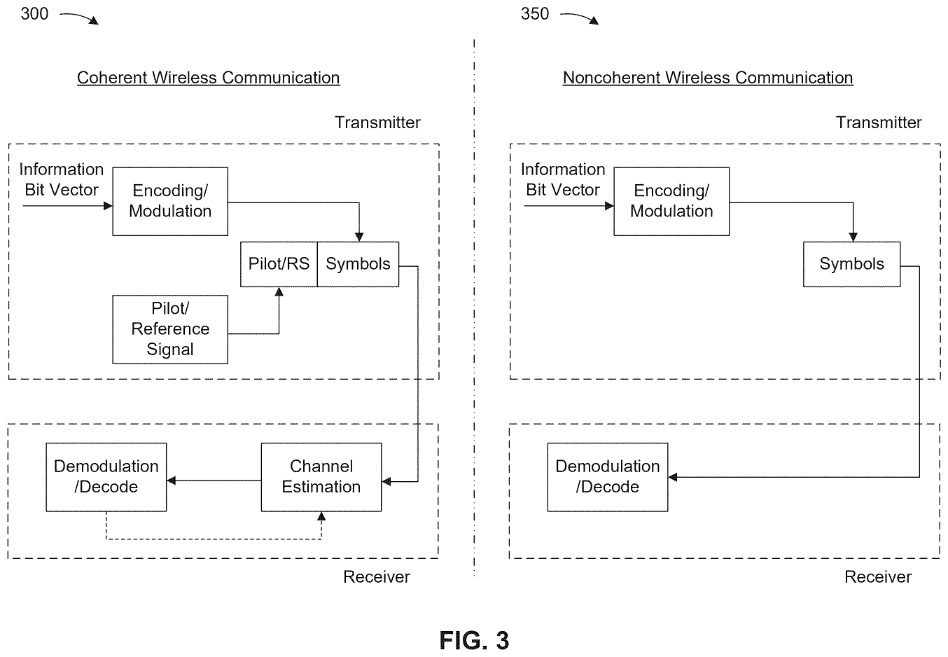

FIG. 3 is a diagram illustrating an example 300 of coherent wireless communication and an example 350 of noncoherent wireless communication, in accordance with various aspects of the present disclosure. The coherent and/or noncoherent wireless communication illustrated in FIG. 3 may be performed by wireless communication devices, such as a UE 120 and a network node 110 communicating over an access link, a UE 120 and another UE 120 communicating over a sidelink, and/or the like.

As shown in FIG. 3, and by example 300, coherent wireless communication may involve the use of pilot signals and/or reference signals. A wireless communication device (referred to herein as a “transmitter”) may transmit an information bit vector (e.g., a string of bits carrying one or more types of information) by encoding the information bit vector to form one more codewords that each include multiple coded bits. The transmitter may modulate the codewords to form one or more OFDM symbols, generate a pilot signal or reference signal associated with the one or more OFDM symbols (e.g., a demodulation reference signal (DMRS) and/or another suitable reference signal), and transmit the pilot/reference signal and the OFDM symbols over a wireless physical channel (e.g., a PxxCH, which may be a PDCCH, a PDSCH, a PUCCH, a PUSCH, a physical sidelink control channel (PSCCH), and/or a physical sidelink shared channel (PSSCH)). The pilot/reference signal and the OFDM symbols may be transmitted over the wireless physical channel to another wireless communication device (referred to as a “receiver”).

As further shown in FIG. 3, the receiver may receive the pilot/reference signal and the OFDM symbols via the physical channel, and may use the pilot/reference signal to obtain CSI associated with the physical channel. For example, the receiver may demodulate and decode the pilot/reference signal and the OFDM symbols, may perform a channel estimation of the physical channel based at least in part on the demodulation and/or decoding of the pilot/reference signal, and may adjust or modify demodulation and/or decoding parameters for the receiver based at least in part on the channel estimation in order to increase the efficiency and performance of demodulation and/or decoding for the receiver.

In some cases, coherent communication in a wireless system may be suboptimal at a low signal-to-noise ratio (SNR). For example, the energy used to transmit, decode, and/or measure pilot/reference signals may be wasted because, at low SNR (e.g., an SNR that satisfies a low threshold, such as 0-5 decibels (dB)), pilot/reference signals may contain little to no useful information for the receiver. Moreover, attempting to perform a channel estimation at low SNR may result in an inaccurate and/or poor quality channel estimation, which in turn may result in degraded performance in demodulation and/or decoding. Additionally, or alternatively, coherent wireless communication may be suboptimal in other use cases, such as a high Doppler scenario (e.g., when the transmitter and/or the receiver are moving at a fast rate), when transmitted packets have a small payload size (e.g., such that the transmitted packets cannot accommodate the additional payload of a pilot signal or a DMRS), and/or asynchronous communication use cases, among other examples. As one example, an IoT device operating at an edge of a cell, an indoor environment, and/or an obstructed urban environment, may operate with a communication channel that has a low SNR.

Accordingly, as further shown in FIG. 3, and by example 350, a transmitter and a receiver may perform noncoherent communication to increase demodulation and/or decoding performance in low SNR scenarios. As described herein, “noncoherent communication” may generally refer to a wireless communication scheme in which the transmitter does not transmit any pilot signals or reference signals for OFDM symbols carrying data/information (e.g., a PxxCH without a DMRS). Alternatively, or additionally, the receiver directly demodulates and decodes the received OFDM symbols without performing a channel estimation based on a pilot signal or reference signal.

As indicated above, FIG. 3 is provided as an example. Other examples may differ from what is described with regard to FIG. 3.

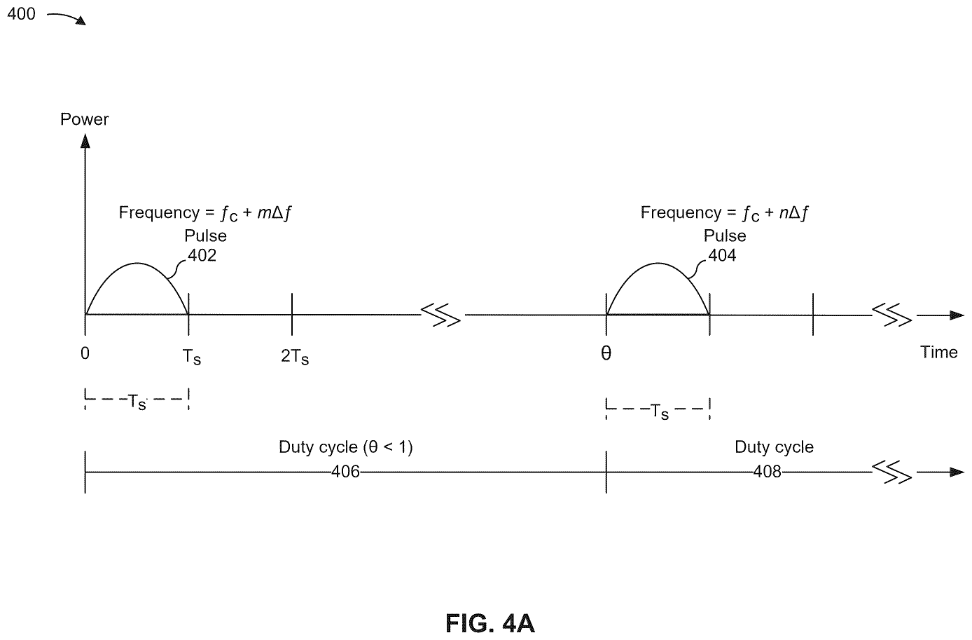

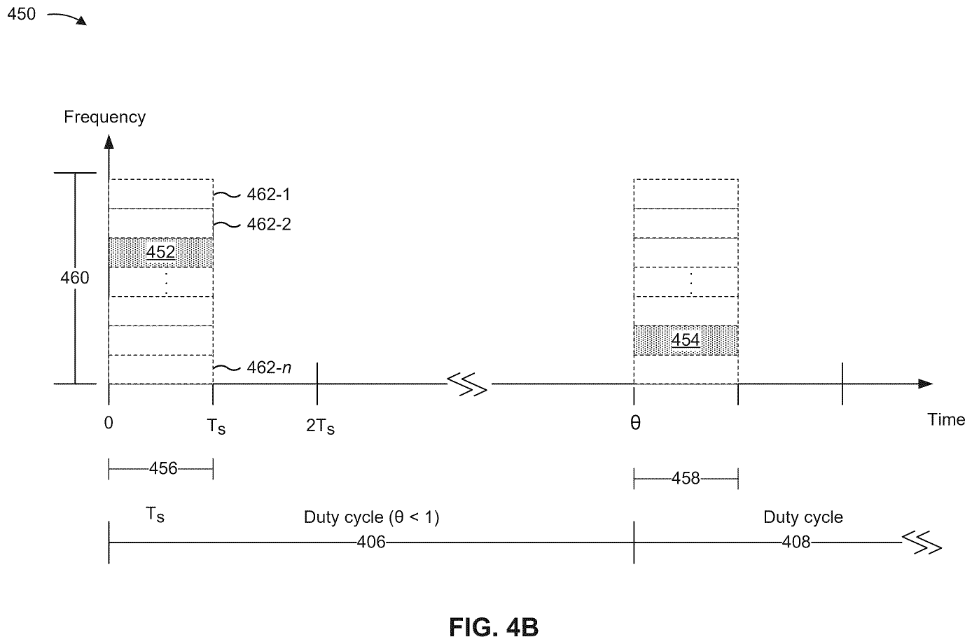

FIGS. 4A and 4B are diagrams illustrating a first example 400 and a second example 450 of consecutive duty-cycle-based symbols, in accordance with the present disclosure.

Coherent communications may be based at least in part on a transmitter transmitting a pilot and/or reference signal and a receiver using the pilot and/or reference signal to compute a channel estimation of a physical channel. As part of the coherent communications, the receiver may use the channel estimation to adjust or modify demodulation and/or decoding parameters. Some channel conditions may be suboptimal for coherent communications, such as a low SNR operating environment in which an SNR observed by the receiver satisfies a low threshold, resulting in increased recovery errors at the receiver. In such an operating environment, noncoherent communications may provide reduced recovery errors, relative to coherent communications. In noncoherent communications, the transmitter does not transmit any pilot signals or reference signals, and the receiver directly demodulates and decodes the received symbols without computing a channel estimation for adjustments. In some cases, a measurement metric observed at the receiver (e.g., a received power level and/or an observed SNR) may indicate when current channel conditions are suboptimal for coherent communications. As a result, the transmitter and the receiver may switch to noncoherent communications to mitigate decoding errors.

The first example 400 is an example noncoherent transmission that is based at least in part on consecutive duty-cycle-based symbols, which may also be referred to as a peaky transmission (e.g., a transmission that includes bursts of information). To illustrate, a transmitter may transmit a first symbol as a first pulse 402 that spans a time period of Tₛ and is located at a frequency of f_{c}+mΔf, where f_{c} denotes a carrier frequency, m is an integer, and Δf denotes a frequency partition and/or a sub-band width. As one example, f_{c} may be associated with a bandwidth, and the bandwidth may be partitioned into sub-bands and/or sub-bandwidths. A transmitter may position the first pulse 402 in a particular sub-band of the bandwidth (denoted in FIG. 4A as mΔf) to indicate a particular symbol, as described with regard to FIG. 4B. The transmitter may transmit a second symbol as a second pulse 404 that spans a time period of Tₛ and is located at a frequency of f_{c}+nΔf, where n is a second integer that may have a different value than m. Thus, a positioning of the pulse within the carrier bandwidth may convey additional information, as described below. The first pulse 402 and the second pulse 404 are separated in the time domain by a first duty cycle 406 that is shown in FIG. 4A as having a duration θ, where θ has a value that is greater than zero and is less than one. In some examples, the first pulse 402 and/or the second pulse 404 may carry and/or be respective OFDM symbols (e.g., duty-cycle-based OFDM symbols and/or peaky OFDM symbols).

Each pulse transmission and, consequently, each symbol, occurs during a portion, and not the entirety, of a respective duty cycle. For instance, the first duty cycle 406 is shown in FIG. 4A as being based at least in part on multiple periods (e.g., multiple Tₛ), and the transmitter may transmit a single pulse (e.g., pulse 402) in one of the multiple Tₛ that are included in the first duty cycle 406, and the first pulse 402 is based at least in part on a duty cycle ratio of Tₛ/θ. The transmitter delays transmission of the second pulse 404 until the start of a second duty cycle 408 that has a same duration θ as the first duty cycle 406. In a similar manner as the first pulse 402, the second pulse may be based at least in part on a duty cycle ratio of Tₛ/θ. As shown by FIG. 4A, the first pulse 402 and the second pulse 404 are associated with respective symbols, occur in consecutive duty cycles, and each occur in a respective portion of the respective duty cycle. Accordingly, the first pulse 402 and the second pulse 404 may alternatively be referred to as consecutive duty-cycle-based symbols, and the consecutive duty-cycle-based symbols may occupy non-contiguous time-frequency resources.

In some cases, as part of transmitting a duty-cycle-based symbol, a transmitter may increase a peak transmit power of a pulse (e.g., in proportion to an inverse of the associated duty cycle) in a manner that concentrates transmission power over time and frequency. To illustrate, each pulse may be transmitted based at least in part on a respective duty cycle that has a duration of θ as described above, and a peak power of each pulse may be configured as: P/θ (e.g., as long as the respective regulations and device capability are complied), where P is the average power and

$$\frac{P}{θ} > P .$$

As indicated above, the transmitter may transmit different frequencies (e.g., within a carrier bandwidth and/or using sub-bands of a carrier) to indicate different symbol values.

The second example 450 that is shown by FIG. 4B includes two consecutive duty-cycle-based symbols, shown as a first duty-cycle-based symbol 452 and a second duty-cycle-based symbol 454, that indicate respective information based at least in part on a respective frequency partition that is used to carry the duty-cycle-based symbol. To illustrate, the first duty-cycle-based symbol 452 and the second duty-cycle-based symbol 454 are separated from one another in the time domain by the first duty cycle 406 that has a duration of θ as described with regard to the first example 400. The first duty-cycle-based symbol 452 occupies a first time partition 456 of the first duty cycle 406, where the first time partition 456 spans Tₛ. In a similar manner, the second duty-cycle-based symbol 454 occupies a second time partition 458 of the second duty cycle 408, where the second duty-cycle-based symbol 454 also spans Tₛ.

A first time partition that is associated with the first duty-cycle-based symbol 456 and a second time partition that is associated with the second duty-cycle-based symbol 454 are each associated with a bandwidth 460, the bandwidth 460 may be partitioned into sub-bands, and each sub-band in combination with the associated time partition (e.g., the first time partition 456 and/or the second time partition 458) may be referred to as an RE. For example, the first time partition 456 may be associated with a first RE 462-1 that is based at least in part on a first sub-band of the bandwidth 460, a second RE 462-2 that is associated with a second sub-band of the bandwidth 460, and an n-th RE 462-n that is associated with an n-th sub-band of the bandwidth 460. FIG. 4B illustrates each RE of the first time partition 456 and the second time partition 454 as a rectangle with a dotted outline.

In some cases, a transmitting device may select a particular sub-band and/or a particular RE out of the multiple sub-bands and/or the multiple REs to indicate information. To illustrate, each RE in the first time partition 456 may be associated with a respective bit pattern: the first RE 462-1 may be associated with a first bit pattern “0000”, the second RE 462-2 may be associated with a second bit pattern (e.g., “0001”), and the n-th RE 462-n may be associated with an n-th bit pattern (e.g., “1111”). A transmitting device may select a first particular RE out of the available REs that are associated with the first time partition 456 based at least in part on a bit pattern associated with the first particular RE, and may transmit the first duty-cycle-based symbol 452 in the first particular RE (shown with a dotted pattern) to indicate the bit pattern associated with the first particular RE. In a similar manner, the transmitting device may select a second particular RE out of the available REs that are associated with the second time partition 458 based at least in part on a bit pattern associated with the second particular RE, and may transmit the second duty-cycle-based symbol 454 in the second particular RE (shown with a dotted pattern) to indicate the bit pattern associated with the second particular RE.

Being a noncoherent transmission, a set of consecutive duty-cycle-based symbols may enable more reliable communications (e.g., reduced recovery errors) in a low SNR environment relative to coherent transmissions. Scheduling duty-cycle-based symbols using scheduling that is configured and/or optimized for coherent transmissions may lead to inefficiencies, such as increased power consumption at a UE and/or increased signaling overhead. For example, scheduling techniques that are optimized for coherent transmissions may be based at least in part on allocations that use contiguous and/or adjacent air interface resources (e.g., contiguous resource scheduling) to maximize resource efficiencies and/or to minimize signaling overhead. To illustrate, various RATs allocate air interface resources based at least in part on using contiguous time-frequency resources and, in some cases, the contiguous time-frequency resources may be scheduled periodically or semi-persistently. Using scheduling that is based at least in part on contiguous time-frequency resource allocations may be sub-optimal for duty-cycle-based symbols that occupy non-contiguous time-frequency resources. To illustrate, a contiguous resource scheduling mechanism may schedule contiguous air interface resources for a set of contiguous duty-cycle-based symbols, and some air interface resources may go unused, such as the air interface resources between the duty-cycle-based symbols as described above with regard to FIG. 4B. Inefficient air interface resource allocations that result in unused air interface resources may lead to a decreased availability of air interface resources for other communications, and the decreased availability of air interface resources may result in reduced data throughput and/or increased data transfer latencies in a wireless network.

Various aspects relate generally to a dynamic uplink grant for a set of consecutive duty-cycle-based symbols. Some aspects more specifically relate to a network node scheduling a UE with a dynamic uplink grant for one or more duty-cycle-based symbols, some of which may be included in a set of contiguous duty-cycle-based symbols. The dynamic uplink grant may allocate non-contiguous time-frequency resources to the UE. In some aspects, a network node may transmit an indication of a dynamic uplink grant for a set of consecutive duty-cycle-based symbols. For instance, the network node may transmit the indication of the dynamic uplink grant for the set of consecutive duty-cycle-based symbols based at least in part on transmitting a respective dynamic uplink grant for each duty-cycle-based symbol in respective DCI. That is, the dynamic uplink grant for an entirety of consecutive duty-cycle-based symbols may be based at least in part on multiple DCI transmissions. As another example, the network node may transmit the indication of the dynamic uplink grant in a single DCI transmission that allocates non-contiguous air interface resources as described below. The network node may receive the set of consecutive duty-cycle-based symbols based at least in part on the dynamic uplink grant.

In some aspects, a UE may receive an indication of a dynamic uplink grant for a set of consecutive duty-cycle-based symbols. As one example, the UE may receive a respective dynamic uplink grant for each duty-cycle-based symbol in the set of consecutive duty-cycle-based symbols, such as by receiving respective DCI that schedules a respective duty-cycle-based symbol. As another example, the UE may receive a single DCI that allocates non-contiguous air interface resources for an entirety of the set of contiguous duty-cycle-based symbols. The UE may transmit the set of consecutive duty-cycle-based symbols based at least in part on the dynamic uplink grant.

Particular aspects of the subject matter described in this disclosure can be implemented to realize one or more of the following potential advantages. In some examples, by transmitting an indication of a dynamic uplink grant for a set of duty-cycle-based symbols, the described techniques can be used to enable a network node to increase an efficiency with respect to how air interface resources are allocated and used by reducing the allocation of unused air interface resources. To illustrate, by allocating non-contiguous air interface resources based at least in part on a duty cycle of the symbols, the network node may allocate air interface resources that are positioned between the duty-cycle-based symbols to other communications. Increasing an efficiency of how air interface resources are used and/or allocated may increase an availability of air interface resources for other communications, resulting in increased data throughput and/or reduced data transfer latencies in a wireless network.

As indicated above, FIGS. 4A and 4B are provided as examples. Other examples may differ from what is described with regard to FIGS. 4A and 4B.

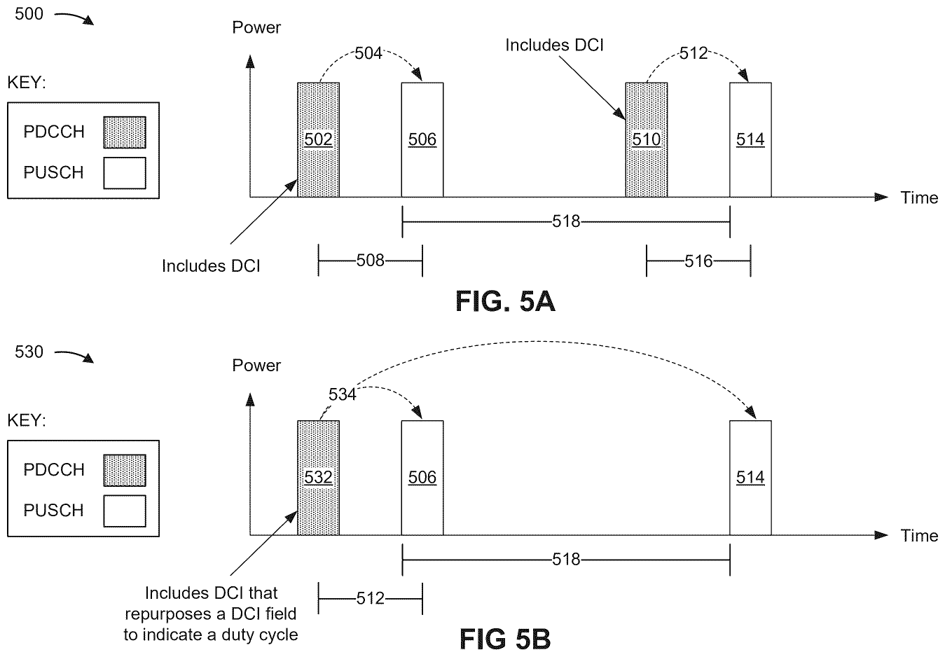

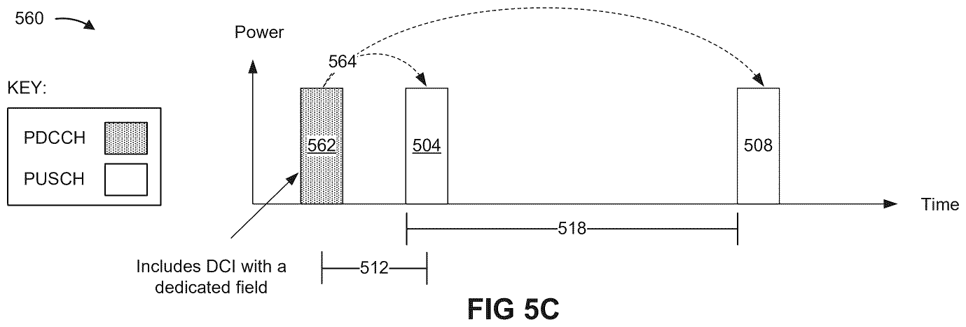

FIGS. 5A, 5B, and 5C are diagrams illustrating a first example 500, a second example 530, and a third example 560 of dynamic scheduling mechanisms for consecutive duty-cycle-based symbols, in accordance with the present disclosure.

A UE (e.g., a UE 120) may receive an indication of dynamic scheduling for a set of duty-cycle-based symbols, and the dynamic scheduling may indicate a dynamic uplink grant that is based at least in part on a duty-cycle-based allocation (e.g., an allocation that includes non-contiguous air interface resources based at least in part on a duty cycle). As described with regard to FIGS. 4A and 4B, a respective duty-cycle-based symbol in a set of consecutive duty-cycle-based symbols may occupy a symbol duration of Tₛ in a respective duty cycle θ that has a value of less than or equal to one (e.g., θ≤1), and consecutive duty-cycle-based symbols may be separated in the time domain by

$$\frac{{T}_{s}}{θ} .$$

The UE may receive the indication of the dynamic scheduling based at least in part on transmitting a request for a dynamic uplink grant, such as in a RACH procedure and/or in a scheduling request carried in PUCCH. In some aspects, a network node may transmit the indication of the dynamic scheduling for one or more duty-cycle-based symbols in DCI.

The first example 500 shown in FIG. 5A is a first example dynamic scheduling mechanism for one or more duty-cycle-based symbols that may be used for a single duty-cycle-based symbol and/or a set of consecutive duty-cycle-based symbols. In the first example 500, a network node (e.g., a network node 110) may transmit respective DCI via PDCCH that schedules a respective duty-cycle-based symbol. For instance, the network node may transmit first PDCCH 502 that includes first DCI, and, as shown by reference number 504, the first DCI may indicate first scheduling information and/or a first dynamic grant in first PUSCH 506 for a first duty-cycle-based symbol. To ensure that a UE (e.g., a UE 120) receives, processes, and decodes the dynamic grant indicated the first DCI in sufficient time to use the first dynamic grant, the network node may transmit the first PDCCH 502 based at least in part on a first offset 508 that is based at least in part on the first dynamic grant (e.g., a time location of the first PUSCH 506). The network node may also transmit second PDCCH 510 that includes second DCI and, as shown by reference number 512, the second DCI may indicate second scheduling information and/or a second dynamic grant in second PUSCH 514 for a second duty-cycle-based symbol. In a similar manner as the first PDCCH 502, the network node may transmit the second PDCCH 510 based at least in part on a second offset 516 to ensure that the UE receives, processes, and decodes the dynamic grant indicated by the second DCI in sufficient time to use the second dynamic grant.

The first DCI in the first PDCCH 502 and the second DCI in the second PDCCH 510 may, collectively, provide an indication of dynamic scheduling and/or a dynamic uplink grant for a set of consecutive duty-cycle-based symbols. As shown by FIG. 5A, the first PUSCH 506 and the second PUSCH 514 are separated by a duty cycle 518 that is associated with the duty-cycle-based symbols as described with regard to FIGS. 4A and 4B. While the first example 500 includes the network node indicating a dynamic uplink grant for two consecutive duty-cycle-based symbols, other examples may include the network node scheduling one duty-cycle-based symbol. In some aspects, the respective DCI that schedules a respective duty-cycle-based symbol (e.g., in a set of consecutive duty-cycle-based symbols or a single duty-cycle-based symbol) may use a DCI format that is associated with scheduling a dynamic uplink grant, such as DCI Format 0_0 and/or DCI Format 0_1. Alternatively, or additionally, the respective DCI that schedules a respective duty-cycle-based symbol may be scrambled using a cell radio network temporary identifier (C-RNTI) that is assigned to and/or associated with the UE (e.g., after a RACH procedure) being scheduled with the dynamic uplink grant. Alternatively, or additionally, the respective DCI may use a DCI format that is not modified to include a dedicated field for scheduling duty-cycle-based symbols. For example, the DCI format may be a traditional, conventional, and/or legacy DCI format that may be sent to, and understood by, a first UE that supports dynamic scheduling of duty-cycle-based symbols and a second UE that does not support dynamic scheduling of duty-cycle-based symbols.

In the first example 500, a UE receiving the respective DCI that schedules the respective duty-cycle-based symbol may transmit each duty-cycle-based symbol without an explicit indication of the duty cycle and/or a duration of the duty cycle. To illustrate, the network node may transmit multiple DCI to schedule a set of consecutive duty-cycle-based symbols based at least in part on the duty cycle as shown by FIG. 5A. Accordingly, the duty cycle may be implicitly indicated through timing locations of the dynamic uplink grants and not be explicitly indicated (e.g., via a dedicated field and/or a repurposed field) to the UE.

The second example 530 shown in FIG. 5B is a second example dynamic scheduling mechanism for one or more duty-cycle-based symbols that may be used for a single duty-cycle-based symbol and/or a set of consecutive duty-cycle-based symbols. In the second example 530, a network node may transmit one DCI that indicates a dynamic uplink grant for one or more consecutive duty-cycle-based symbols, instead of multiple DCI as described with regard to the first example 500.

To illustrate, a network node may transmit a PDCCH 532 that includes DCI and, as shown by reference number 534, the DCI may include dynamic scheduling information that indicates a dynamic uplink grant for the first PUSCH 506 and the second PUSCH 514. The uplink grant for the first PUSCH 506 and the second PUSCH 514 may include a resource allocation that is based at least in part on a duty cycle (e.g., the duty cycle 518), such as a first set of REs as described with regard to the first time partition 456 and a second set of REs as described with regard to the second time partition 458, as described with regard to FIG. 4B. Alternatively, or additionally, the dynamic uplink grant may not include and/or may not allocate air interface resources (e.g. REs) that are located in the time domain between the first PUSCH 506 and the second PUSCH 514. To illustrate, and with regard to FIG. 4B, the dynamic uplink grant may not include one or more REs that are located between the first time partition 456 and the second time partition 458.

In some aspects, the DCI may indicate the dynamic uplink grant based at least in part on reusing and/or repurposing an existing field in the DCI. For instance, the network node may transmit the DCI using a DCI format that includes a reserved field, and the network node may use the reserved field to indicate a duty cycle of the uplink grant (e.g., a duty cycle that is associated with a set of consecutive duty-cycle-based symbols). Additional fields within the DCI may be used to indicate one or more air interface resources that are included in the uplink grant. Repetitions of the one or more air interface resources that are included in the uplink grant may be based at least in part on the indicated duty cycle. For instance, the network node may indicate the duty cycle 518 in a reused field and/or a repurposed field of the DCI and/or may indicate one or more air interface resources that are associated with the first PUSCH 506 in other fields of the DCI. Based at least in part on the indication of a duty cycle, the dynamic uplink grant may implicitly include additional air interface resources that are based at least in part on the indicated duty cycle, such as the air interface resources of the second PUSCH 514.

A duration of the dynamic uplink grant and/or number of duty cycle allocations that are included in the dynamic uplink grant may be based at least in part on a request from a UE receiving the dynamic uplink grant. That is, the UE may transmit a request for a dynamic uplink grant, and the request may indicate a number of consecutive duty-cycle-based symbols associated with the request. The number of duty cycle allocations included in the dynamic uplink grant indicated in the DCI may implicitly include the number of consecutive duty-cycle-based symbols associated with the request. However, in other examples, the DCI may repurpose a field to indicate the number of consecutive duty-cycle-based symbols associated with the uplink grant. Accordingly, the dynamic uplink grant indicated by the DCI in the PDCCH 532 may include one or more air interface resources in respective time partitions of respective duty-cycle-based symbols in a set of consecutive duty-cycle-based symbols, may not include one or more air interface resource that are between the respective time partitions of the respective duty-cycle-based symbol(s), may include non-contiguous air interface resources, and/or may not include air interface resources that are contiguous in the time domain.

To indicate that an existing DCI field has been reused and/or repurposed to indicate a duty cycle, the network node may mask and/or scramble the DCI with a different radio network temporary identifier (RNTI) than a C-RNTI assigned to the UE. For instance, the network node may configure the UE with an X-RNTI (X being arbitrary) that is dedicated to and/or associated with indicating that a DCI field has been repurposed and/or reused to indicate a duty cycle for a duty-cycle-based allocation (e.g., that includes non-contiguous air interface resources based at least in part on a duty cycle). The network node may scramble and/or mask the DCI and/or a cyclic redundancy check (CRC) associated with the DCI with the X-RNTI to indicate that the DCI includes duty cycle information and/or that a DCI field has been repurposed to indicate the duty cycle. The use of a different scrambling sequence than the C-RNTI (e.g., the X-RNTI) may enable a UE to correctly decode information in the DCI field, such as by decoding originally defined information (e.g., as a reserved field) in the DCI field or decoding redefined information (e.g., a duty cycle) in the DCI field.

The use of a single DCI to indicate a dynamic uplink grant for one or more duty-cycle-based symbols, such as a set of consecutive duty-cycle-based symbols, may reduce signaling overhead relative to the first example 500, resulting in more air interface resources being available for other communications, increased data throughput, and/or reduced data transfer latencies in a wireless network. In some aspects, the use of a single DCI to indicate a dynamic uplink grant for one or more duty-cycle-based symbols may reduce power consumption by a UE by reducing an amount of signal reception and/or signal decoding performed by the UE relative to the first example 500. Alternatively, or additionally, the use of a single DCI to indicate a dynamic uplink grant for one or more duty-cycle-based symbols may mitigate disruptions in an uplink grant that are based at least in part on the UE missing at least one of multiple DCIs that, collectively, indicate a dynamic uplink grant for a set of consecutive duty-cycle-based symbols. The repurposing of a DCI field may enable the network node to use a DCI format that is not modified to include a dedicated field for indicating the duty cycle field. That is, the network node may use a traditional, conventional, and/or legacy DCI format that may be sent to, and understood by, a first UE that supports dynamic scheduling of duty-cycle-based symbols and a second UE that does not support dynamic scheduling of duty-cycle-based symbols.

The third example 560 shown in FIG. 5C is a third example dynamic scheduling mechanism for one or more duty-cycle-based symbols that may be used for a single duty-cycle-based symbol and/or a set of consecutive duty-cycle-based symbols. In the third example 560, a network node may transmit one DCI that indicates an uplink grant for one or more duty-cycle-based symbols, instead of multiple DCI as described with regard to the first example 500.

To illustrate, a network node may transmit a PDCCH 562 that includes DCI and, as shown by reference number 564, the DCI may include dynamic scheduling information that indicates an uplink grant for the first PUSCH 506 and the second PUSCH 514. In a similar manner as described with regard to FIG. 5B, the uplink grant for the first PUSCH 506 and the second PUSCH 514 may be a duty-cycle-based allocation that includes non-contiguous air interface resources based at least in part on a duty cycle and/or does not include air interface resources that are contiguous in the time domain.

To illustrate, the DCI may be based at least in part on a DCI format that includes a dedicated field that indicates a duty cycle (e.g., the duty cycle 518). In a similar manner as the second example 530, additional fields within the DCI may be used to indicate one or more air interface resources that are included in the dynamic uplink grant, and repetitions of the one or more air interface resources may also be included in the dynamic uplink grant based at least in part on the indicated duty cycle. A duration of the dynamic uplink grant and/or number of duty cycle allocations that are included in the dynamic uplink grant may be based at least in part on a request from a UE receiving the dynamic uplink grant. Accordingly, the number of duty cycle allocations included in the dynamic uplink grant indicated in the DCI may implicitly include the number of consecutive duty-cycle-based symbols associated with the request. However, in other examples, the DCI may include a field that indicates the number of consecutive duty-cycle-based symbols associated with the dynamic uplink grant.

In some aspects, the DCI that includes a dedicated field to indicate a duty cycle may be scrambled using a C-RNTI that is assigned to and/or associated with the UE. The use of the C-RNTI that is associated to the UE may reduce a number of blind deconvolutions performed by a UE relative to the second example 530 and, consequently, reduce power consumption by the UE. To illustrate, a UE may perform a single deconvolution using the C-RNTI to detect an uplink grant in the DCI relative to multiple deconvolutions using multiple RNTIs. Alternatively, or additionally, using the C-RNTI to scramble the DCI may preserve backward compatibility with UEs that do not include support for duty-cycle-based allocations. In a similar manner as described with regard to the second example 530, the use of a single DCI to indicate a dynamic uplink grant for one or more duty-cycle-based symbols may reduce signaling overhead relative to the first example 500, resulting in more air interface resources being available for other communications, increased data throughput, and/or reduced data transfer latencies in a wireless network. Alternatively, or additionally, the use of a single DCI to indicate a dynamic uplink grant for one or more duty-cycle-based symbols may reduce power consumption by a UE, by reducing an amount of signal reception and/or signal decoding performed by the UE relative to the first example 500.

As indicated above, FIGS. 5A, 5B, and 5C are provided as examples. Other examples may differ from what is described with regard to FIGS. 5A, 5B, and 5C.

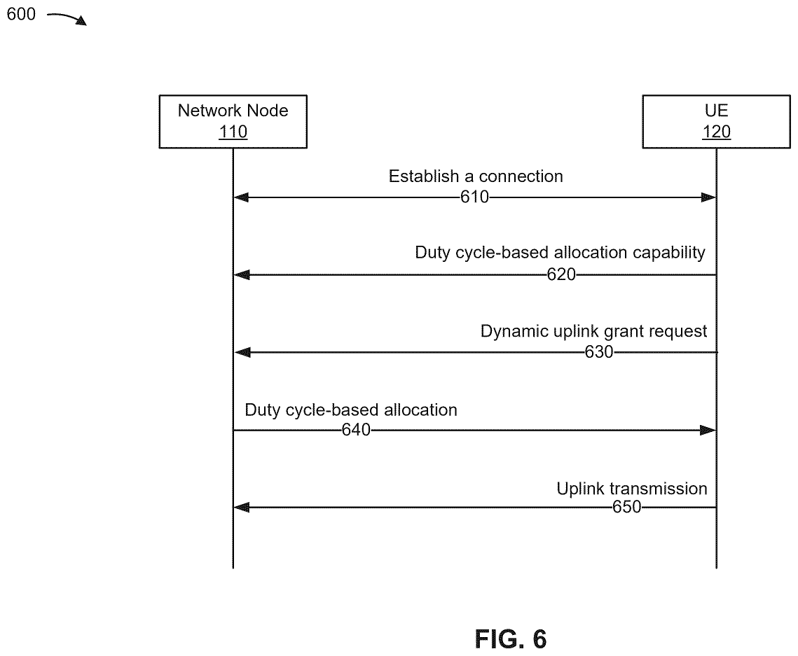

FIG. 6 is a diagram illustrating an example 600 of a wireless communication process between a network node (e.g., the network node 110) and a UE (e.g., the UE 120), in accordance with the present disclosure.

As shown by reference number 610, a network node 110 and a UE 120 may establish a connection. To illustrate, the UE 120 may power up in a cell coverage area provided by the network node 110, and the UE 120 and the network node 110 may perform one or more procedures (e.g., a RACH procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., DCI and/or UCI), Layer 2 signaling (e.g., a MAC CE), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE 120 being tolerant of communication delays, and the network node 110 may transmit an activation of the configuration via Layer 2 signaling and/or Layer 1 signaling at a second point in time associated with the UE being less tolerant to communication delays.

As shown by reference number 620, the UE 120 may transmit, and the network node 110 may receive, an indication of a duty-cycle-based allocation capability. As one example, the UE 120 may indicate support for DCI that indicates a duty-cycle-based allocation, such as DCI that repurposes an existing field to indicate a duty cycle and/or support for an additional RNTI (e.g., an X-RNTI) as described with regard to the second example 530 of FIG. 5B. As another example, the UE 120 may indicate support for a DCI format that includes a dedicated field for indicating a duty cycle as described with regard to the third example 560 of FIG. 5C. The UE indicating support (or not indicating support) of a duty-cycle-based allocation capability may enable the network node 110 to select a scheduling format and/or a DCI format that is supported by the UE 120 to indicate an uplink grant for one or more duty-cycle-based symbols. To illustrate, based at least in part on the UE 120 not indicating support for a duty-cycle-based allocation, the network node 110 may schedule a set of consecutive duty-cycle-based symbols using the first example scheduling mechanism described with regard to FIG. 5A that includes the network node 110 using a DCI format that is supported by the UE 120 (e.g., a DCI format that does not indicate a duty cycle) and managing a timing of the scheduling (e.g., and without indicating a duty cycle in DCI). As a second example, based at least in part on the UE 120 indicating support for a duty-cycle-based allocation, the network node 110 may schedule a set of consecutive duty-cycle-based symbols using a scheduling mechanism that reduces signaling overhead, such as the second scheduling mechanism described with regard to FIG. 5B and/or the third scheduling mechanism described with regard to FIG. 5C

For clarity, FIG. 6 illustrates the UE 120 transmitting the indication of the duty-cycle-based allocation capability in a separate transaction than establishing a connection with the network node 110 in the example 500. However, in some aspects, the UE 120 may transmit the indication of the duty-cycle-based allocation capability as part of establishing a connection with the network node 110.

As shown by reference number 630, the UE 120 may transmit, and the network node 110 may receive, a dynamic uplink grant request. As one example, the UE 120 may transmit the dynamic uplink grant request in a RACH procedure. As another example, the UE 120 may transmit the dynamic uplink grant request as a scheduling request that is transmitted via a PUCCH. The dynamic uplink grant request may indicate a grant size request, such as a number of duty-cycle-based symbols associated with the dynamic uplink grant request.

As shown by reference number 640, the network node 110 may transmit, and the UE 120 may receive, an indication of a duty-cycle-based allocation and/or an indication of a dynamic uplink grant for one or more duty-cycle-based symbols (e.g., a single duty-cycle-based symbol or a set of consecutive duty-cycle-based symbols). In some aspects, the duty-cycle-based allocation and/or the dynamic uplink grant is associated with a PUSCH. That is, the duty-cycle-based allocation and/or the dynamic uplink grant indicates an assignment of air interface resources in the PUSCH.

As a first example, the network node 110 may transmit respective DCI for each respective duty-cycle-based symbol in a set of consecutive duty-cycle-based symbols using the first example scheduling mechanism as described with regard to FIG. 5A, and each respective DCI may indicate respective scheduling for a respective duty-cycle-based symbol as at least part of the dynamic uplink grant. That is, the network node may indicate a respective portion of a dynamic uplink grant (e.g., a portion that is associated with a respective duty-cycle-based symbol) in respective DCI. The respective DCI may be masked and/or scrambled with a C-RNTI that is associated with the UE 120. In some aspects, the network node 110 may transmit the indication of a dynamic uplink grant for a set of consecutive duty-cycle-based symbols using the multiple DCI based at least in part on the UE 120 not indicating support for duty-cycle-based allocations.

As a second example, the network node 110 may transmit the indication of the dynamic uplink grant in a single instance of DCI as described with regard to FIG. 5B and the second example scheduling mechanism, and with regard to FIG. 5C and the third example scheduling mechanism. The single instance of DCI may indicate an entirety of the dynamic uplink grant for the set of consecutive duty-cycle-based symbols (or a single duty-cycle-based symbol) and/or a duty cycle that is associated with the set of consecutive duty-cycle-based symbols.

For instance, as described with regard to FIG. 5B, the single DCI may include a repurposed field that indicates the duty cycle, and the network node 110 may scramble and/or mask the single DCI using an RNTI that indicates the DCI includes the repurposed field. For instance, the network node 110 may use an RNTI that is different from a C-RNTI that is assigned to the UE 120, such as an X-RNTI as described above. As another example, as described with regard to FIG. 5C, the single DCI may use a DCI format that includes an explicit field that is dedicated to indicating the duty cycle (e.g., a dedicated field for indicating a duty cycle). Accordingly, the explicit field and/or the dedicated field is not a repurposed field. In using an explicit field and/or dedicated field, the network node 110 may scramble and/or mask the DCI using the C-RNTI that is assigned to the UE 120.

As shown by reference number 650, the UE 120 may transmit, and the network node 110 may receive, an uplink transmission. To illustrate, the UE 120 may transmit a set of consecutive duty-cycle-based symbols based at least in part on the dynamic uplink grant. Each duty-cycle-based symbol may have a symbol duration of Tₛ and may be based at least in part on a duty cycle of θ. In some aspects, each duty-cycle-based symbol in the set of consecutive duty-cycle-based symbols is based at least in part on a duty cycle ratio of Tₛ/θ.

By transmitting an indication of a dynamic uplink grant for a set of duty-cycle-based symbols, a network node may increase an efficiency of allocating air interface resources by reducing the allocation of unused air interface resources. To illustrate, by allocating non-contiguous air interface resources based at least in part on a duty cycle of the symbols, the network node may allocate air interface resources between the duty-cycle-based symbols to other communications. Increasing an efficiency of how air interface resources are used and/or allocated may increase an availability of air interface resources for other communications, resulting in increased data throughput and/or reduced data transfer latencies in a wireless network.

As indicated above, FIG. 6 is provided as an example. Other examples may differ from what is described with regard to FIG. 6.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with dynamic uplink grant for a set of consecutive duty-cycle-based symbols.

As shown in FIG. 7, in some aspects, process 700 may include transmitting an indication of a dynamic uplink grant for a set of consecutive duty-cycle-based symbols (block 710). For example, the network node (e.g., using transmission component 904 and/or communication manager 906, depicted in FIG. 9) may transmit an indication of a dynamic uplink grant for a set of consecutive duty-cycle-based symbols, as described above.

As further shown in FIG. 7, in some aspects, process 700 may include receiving the set of consecutive duty-cycle-based symbols based at least in part on the dynamic uplink grant (block 720). For example, the network node (e.g., using reception component 902 and/or communication manager 906, depicted in FIG. 9) may receive the set of consecutive duty-cycle-based symbols based at least in part on the dynamic uplink grant, as described above.

Process 700 may include additional aspects, such as any single aspect or any combination of aspects described below and/or in connection with one or more other processes described elsewhere herein.

In a first aspect, each duty-cycle-based symbol in the set of consecutive duty-cycle-based symbols has a symbol duration of Tₛ and is based at least in part on a duty cycle of θ, θ being less than or equal to one, and each duty-cycle-based symbol in the set of consecutive duty-cycle-based symbols is based at least in part on a duty cycle ratio of Tₛ/θ.

In a second aspect, transmitting the indication of the dynamic uplink grant includes transmitting respective DCI for each respective duty-cycle-based symbol in the set of consecutive duty-cycle-based symbols, the respective DCI indicating respective scheduling for the respective duty-cycle-based symbol and as at least part of the dynamic uplink grant.

In a third aspect, the respective DCI is masked with a C-RNTI that is associated with a UE being scheduled with the dynamic uplink grant.

In a fourth aspect, the dynamic uplink grant is associated with a physical uplink shared channel.

In a fifth aspect, transmitting the indication of the dynamic uplink grant includes transmitting a single instance of DCI that indicates an entirety of the dynamic uplink grant for the set of consecutive duty-cycle-based symbols, and a duty cycle associated with the set of consecutive duty-cycle-based symbols.

In a sixth aspect, the single DCI includes a repurposed field that indicates the duty cycle, and the single DCI is masked with a RNTI that indicates the DCI includes the repurposed field.

In a seventh aspect, the RNTI is different from a C-RNTI that is assigned to a user equipment associated with the dynamic uplink grant.

In an eighth aspect, the single DCI uses a DCI format that includes an explicit field that is dedicated to indicating the duty cycle.

In a ninth aspect, the explicit field is not a repurposed field.

In a tenth aspect, the single DCI is masked with a C-RNTI that is assigned to a UE associated with the dynamic uplink grant.

In an eleventh aspect, the dynamic uplink grant is a request-based dynamic uplink grant.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with dynamic uplink grant for a set of consecutive duty-cycle-based symbols.

As shown in FIG. 8, in some aspects, process 800 may include receiving an indication of a dynamic uplink grant for a set of consecutive duty-cycle-based symbols (block 810). For example, the UE (e.g., using reception component 1002 and/or communication manager 1006, depicted in FIG. 10) may receive an indication of a dynamic uplink grant for a set of consecutive duty-cycle-based symbols, as described above.

As further shown in FIG. 8, in some aspects, process 800 may include transmitting the set of consecutive duty-cycle-based symbols based at least in part on the dynamic uplink grant (block 820). For example, the UE (e.g., using transmission component 1004 and/or communication manager 1006, depicted in FIG. 10) may transmit the set of consecutive duty-cycle-based symbols based at least in part on the dynamic uplink grant, as described above.

Process 800 may include additional aspects, such as any single aspect or any combination of aspects described below and/or in connection with one or more other processes described elsewhere herein.

In a first aspect, each duty-cycle-based symbol in the set of consecutive duty-cycle-based symbols has a symbol duration of Tₛ and is based at least in part on a duty cycle of θ, θ being less than or equal to one, and each duty-cycle-based symbol in the set of consecutive duty-cycle-based symbols is based at least in part on a duty cycle ratio of Tₛ/θ.

In a second aspect, receiving the indication of the dynamic uplink grant includes receiving respective DCI for each respective duty-cycle-based symbol in the set of consecutive duty-cycle-based symbols, the respective DCI indicating respective scheduling for the respective duty-cycle-based symbol and as at least part of the dynamic uplink grant.

In a third aspect, the respective DCI is masked with a C-RNTI that is associated with the UE.

In a fourth aspect, the dynamic uplink grant is associated with a physical uplink shared channel.

In a fifth aspect, receiving the indication of the dynamic uplink grant includes receiving a single instance of DCI that indicates an entirety of the dynamic uplink grant for the set of consecutive duty-cycle-based symbols, and a duty cycle associated with the set of consecutive duty-cycle-based symbols.

In a sixth aspect, the single DCI includes a repurposed field that indicates the duty cycle, and the single DCI is masked with a RNTI that indicates the DCI includes the repurposed field.

In a seventh aspect, the RNTI is different from a C-RNTI that is assigned to the UE.

In an eighth aspect, the single DCI uses a DCI format that includes an explicit field that is dedicated to indicating the duty cycle.

In a ninth aspect, the explicit field is not a repurposed field.

In a tenth aspect, the single DCI is masked with a C-RNTI that is assigned to the UE.

In an eleventh aspect, the dynamic uplink grant is a request-based dynamic uplink grant, and process 800 includes transmitting a request for the dynamic uplink grant.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4A-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit an indication of a dynamic uplink grant for a set of consecutive duty-cycle-based symbols. The reception component 902 may receive the set of consecutive duty-cycle-based symbols based at least in part on the dynamic uplink grant.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 4A-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive an indication of a dynamic uplink grant for a set of consecutive duty-cycle-based symbols. The transmission component 1004 may transmit the set of consecutive duty-cycle-based symbols based at least in part on the dynamic uplink grant.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a network node, comprising: transmitting an indication of a dynamic uplink grant for a set of consecutive duty-cycle-based symbols; and receiving the set of consecutive duty-cycle-based symbols based at least in part on the dynamic uplink grant.

Aspect 2: The method of Aspect 1, wherein each duty-cycle-based symbol in the set of consecutive duty-cycle-based symbols has a symbol duration of Tₛ and is based at least in part on a duty cycle of θ, θ being less than or equal to one, and wherein each duty-cycle-based symbol in the set of consecutive duty-cycle-based symbols is based at least in part on a duty cycle ratio of Tₛ/θ.

Aspect 3: The method of any of Aspects 1-2, wherein transmitting the indication of the dynamic uplink grant comprises: transmitting respective downlink control information (DCI) for each respective duty-cycle-based symbol in the set of consecutive duty-cycle-based symbols, the respective DCI indicating respective scheduling for the respective duty-cycle-based symbol and as at least part of the dynamic uplink grant.

Aspect 4: The method of Aspect 3, wherein the respective DCI is masked with a cell radio network temporary identifier (C-RNTI) that is associated with a user equipment (UE) being scheduled with the dynamic uplink grant.

Aspect 5: The method of any of Aspects 1-4, wherein the dynamic uplink grant is associated with a physical uplink shared channel.

Aspect 6: The method of any of Aspects 1-5, wherein transmitting the indication of the dynamic uplink grant comprises: transmitting single downlink control information (DCI) that indicates: an entirety of the dynamic uplink grant for the set of consecutive duty-cycle-based symbols, and a duty cycle associated with the set of consecutive duty-cycle-based symbols.

Aspect 7: The method of Aspect 6, wherein the single DCI includes a repurposed field that indicates the duty cycle, and wherein the single DCI is masked with a radio network temporary identifier (RNTI) that indicates the DCI includes the repurposed field.

Aspect 8: The method of Aspect 7, wherein the RNTI is different from a cell RNTI (C-RNTI) that is assigned to a user equipment associated with the dynamic uplink grant.

Aspect 9: The method of Aspect 6, wherein the single DCI uses a DCI format that includes an explicit field that is dedicated to indicating the duty cycle.

Aspect 10: The method of Aspect 9, wherein the explicit field is not a repurposed field.

Aspect 11: The method of Aspect 9 or Aspect 10, wherein the single DCI is masked with a cell radio network temporary identifier (C-RNTI) that is assigned to a user equipment (UE) associated with the dynamic uplink grant.

Aspect 12: The method of any of Aspects 1-11, wherein the dynamic uplink grant is a request-based dynamic uplink grant.

Aspect 13: A method of wireless communication performed by a user equipment (UE), comprising: receiving an indication of a dynamic uplink grant for a set of consecutive duty-cycle-based symbols; and transmitting the set of consecutive duty-cycle-based symbols based at least in part on the dynamic uplink grant.

Aspect 14: The method of Aspect 13, wherein each duty-cycle-based symbol in the set of consecutive duty-cycle-based symbols has a symbol duration of Tₛ and is based at least in part on a duty cycle of θ, θ being less than or equal to one, and wherein each duty-cycle-based symbol in the set of consecutive duty-cycle-based symbols is based at least in part on a duty cycle ratio of Tₛ/θ.

Aspect 15: The method of any of Aspects 13-14, wherein receiving the indication of the dynamic uplink grant comprises: receiving respective downlink control information (DCI) for each respective duty-cycle-based symbol in the set of consecutive duty-cycle-based symbols, the respective DCI indicating respective scheduling for the respective duty-cycle-based symbol and as at least part of the dynamic uplink grant.

Aspect 16: The method of Aspect 15, wherein the respective DCI is masked with a cell radio network temporary identifier (C-RNTI) that is associated with the UE.

Aspect 17: The method of any of Aspects 13-16, wherein the dynamic uplink grant is associated with a physical uplink shared channel.

Aspect 18: The method of any of Aspects 13-17, wherein receiving the indication of the dynamic uplink grant comprises: receiving single downlink control information (DCI) that indicates: an entirety of the dynamic uplink grant for the set of consecutive duty-cycle-based symbols, and a duty cycle associated with the set of consecutive duty-cycle-based symbols.

Aspect 19: The method of Aspect 18, wherein the single DCI includes a repurposed field that indicates the duty cycle, and wherein the single DCI is masked with a radio network temporary identifier (RNTI) that indicates the DCI includes the repurposed field.

Aspect 20: The method of Aspect 19, wherein the RNTI is different from a cell RNTI (C-RNTI) that is assigned to the UE.

Aspect 21: The method of Aspect 18, wherein the single DCI uses a DCI format that includes an explicit field that is dedicated to indicating the duty cycle.

Aspect 22: The method of Aspect 21, wherein the explicit field is not a repurposed field.

Aspect 23: The method of Aspect 21 or Aspect 22, wherein the single DCI is masked with a cell radio network temporary identifier (C-RNTI) that is assigned to the UE.

Aspect 24: The method of any of Aspects 13-23, wherein the dynamic uplink grant is a request-based dynamic uplink grant, and the method further comprises: transmitting a request for the dynamic uplink grant.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-12.

Aspect 26: An apparatus for wireless communication at a device, the apparatus comprising one or more memories and one or more processors coupled to the one or more memories, the one or more processors configured to cause the device to perform the method of one or more of Aspects 1-12.

Aspect 27: An apparatus for wireless communication, the apparatus comprising at least one means for performing the method of one or more of Aspects 1-12.

Aspect 28: A non-transitory computer-readable medium storing code for wireless communication, the code comprising instructions executable by one or more processors to perform the method of one or more of Aspects 1-12.

Aspect 29: A non-transitory computer-readable medium storing a set of instructions for wireless communication, the set of instructions comprising one or more instructions that, when executed by one or more processors of a device, cause the device to perform the method of one or more of Aspects 1-12.

Aspect 30: A device for wireless communication, the device comprising a processing system that includes one or more processors and one or more memories coupled with the one or more processors, the processing system configured to cause the device to perform the method of one or more of Aspects 1-12.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-12.

Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 13-24.

Aspect 33: An apparatus for wireless communication at a device, the apparatus comprising one or more memories and one or more processors coupled to the one or more memories, the one or more processors configured to cause the device to perform the method of one or more of Aspects 13-24.

Aspect 34: An apparatus for wireless communication, the apparatus comprising at least one means for performing the method of one or more of Aspects 13-24.

Aspect 35: A non-transitory computer-readable medium storing code for wireless communication, the code comprising instructions executable by one or more processors to perform the method of one or more of Aspects 13-24.

Aspect 36: A non-transitory computer-readable medium storing a set of instructions for wireless communication, the set of instructions comprising one or more instructions that, when executed by one or more processors of a device, cause the device to perform the method of one or more of Aspects 13-24.

Aspect 37: A device for wireless communication, the device comprising a processing system that includes one or more processors and one or more memories coupled with the one or more processors, the processing system configured to cause the device to perform the method of one or more of Aspects 13-24.

Aspect 38: An apparatus for wireless communication at a device, the apparatus comprising one or more memories and one or more processors coupled to the one or more memories, the one or more processors individually or collectively configured to cause the device to perform the method of one or more of Aspects 13-24.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a network node, comprising:
one or more memories; and
one or more processors, coupled to the one or more memories, configured to cause the network node to:
transmit an indication of a dynamic uplink grant for a set of consecutive duty-cycle-based symbols; and
receive the set of consecutive duty-cycle-based symbols based at least in part on the dynamic uplink grant.

2. The apparatus of claim 1, wherein each duty-cycle-based symbol in the set of consecutive duty-cycle-based symbols has a symbol duration of Tₛ and is based at least in part on a duty cycle of θ, θ being less than or equal to one, and
wherein each duty-cycle-based symbol in the set of consecutive duty-cycle-based symbols is based at least in part on a duty cycle ratio of Tₛ/θ.

3. The apparatus of claim 1, wherein the one or more processors, to cause the network node to transmit the indication of the dynamic uplink grant, are configured to cause the network node to:
transmit respective downlink control information (DCI) for each respective duty-cycle-based symbol in the set of consecutive duty-cycle-based symbols, the respective DCI indicating respective scheduling for the respective duty-cycle-based symbol and as at least part of the dynamic uplink grant.

4. The apparatus of claim 3, wherein the respective DCI is masked with a cell radio network temporary identifier (C-RNTI) that is associated with a user equipment (UE) being scheduled with the dynamic uplink grant.

5. The apparatus of claim 1, wherein the one or more processors, to cause the network node to transmit the indication of the dynamic uplink grant, are configured to cause the network node to:
transmit single downlink control information (DCI) that indicates:
an entirety of the dynamic uplink grant for the set of consecutive duty-cycle-based symbols, and
a duty cycle associated with the set of consecutive duty-cycle-based symbols.

6. The apparatus of claim 5, wherein the single DCI includes a repurposed field that indicates the duty cycle, and
wherein the single DCI is masked with a radio network temporary identifier (RNTI) that indicates the DCI includes the repurposed field.

7. The apparatus of claim 6, wherein the RNTI is different from a cell RNTI (C-RNTI) that is assigned to a user equipment associated with the dynamic uplink grant.

8. The apparatus of claim 5, wherein the single DCI uses a DCI format that includes an explicit field that is dedicated to indicating the duty cycle.

9. The apparatus of claim 8, wherein the single DCI is masked with a cell radio network temporary identifier (C-RNTI) that is assigned to a user equipment (UE) associated with the dynamic uplink grant.

10. A method of wireless communication performed by a network node, comprising:
transmitting an indication of a dynamic uplink grant for a set of consecutive duty-cycle-based symbols; and
receiving the set of consecutive duty-cycle-based symbols based at least in part on the dynamic uplink grant.

11. The method of claim 10, wherein transmitting the indication of the dynamic uplink grant comprises:
transmitting respective downlink control information (DCI) for each respective duty-cycle-based symbol in the set of consecutive duty-cycle-based symbols, the respective DCI indicating respective scheduling for the respective duty-cycle-based symbol and as at least part of the dynamic uplink grant.

12. The method of claim 10, wherein transmitting the indication of the dynamic uplink grant comprises:
transmitting a single downlink control information (DCI) that indicates:
an entirety of the dynamic uplink grant for the set of consecutive duty-cycle-based symbols, and
a duty cycle associated with the set of consecutive duty-cycle-based symbols.

13. The method of claim 12, wherein the single DCI includes a repurposed field that indicates the duty cycle, and
wherein the single DCI is masked with a radio network temporary identifier (RNTI) that indicates the DCI includes the repurposed field.

14. The method of claim 12, wherein the single DCI uses a DCI format that includes an explicit field that is dedicated to indicating the duty cycle.

15. The method of claim 14, wherein the single DCI is masked with a cell radio network temporary identifier (C-RNTI) that is assigned to a user equipment (UE) associated with the dynamic uplink grant.

16. A non-transitory computer-readable medium storing a set of instructions for wireless communication, the set of instructions comprising:
one or more instructions that, when executed by one or more processors of a network node, cause the network node to:
transmit an indication of a dynamic uplink grant for a set of consecutive duty-cycle-based symbols; and
receive the set of consecutive duty-cycle-based symbols based at least in part on the dynamic uplink grant.

17. The non-transitory computer-readable medium of claim 16, wherein the one or more instructions, that cause the network node to transmit the indication of the dynamic uplink grant, cause the network node to:
transmit respective downlink control information (DCI) for each respective duty-cycle-based symbol in the set of consecutive duty-cycle-based symbols, the respective DCI indicating respective scheduling for the respective duty-cycle-based symbol and as at least part of the dynamic uplink grant.

18. The non-transitory computer-readable medium of claim 16, wherein the one or more instructions, that cause the network node to transmit the indication of the dynamic uplink grant, cause the network node to:
transmit single downlink control information (DCI) that indicates:
an entirety of the dynamic uplink grant for the set of consecutive duty-cycle-based symbols, and
a duty cycle associated with the set of consecutive duty-cycle-based symbols.

19. The non-transitory computer-readable medium of claim 18, wherein the single DCI includes a repurposed field that indicates the duty cycle, and
wherein the single DCI is masked with a radio network temporary identifier (RNTI) that indicates the DCI includes the repurposed field.

20. The non-transitory computer-readable medium of claim 18, wherein the single DCI uses a DCI format that includes an explicit field that is dedicated to indicating the duty cycle.
